(19) United States
(12) Patent Application Publication
(10) Pub. No.: US 2004/0187092 A1
(43) Pub. Date: Sep. 23, 2004

(54) Apparatus and method for performing the management of devices

(75) Inventor: Akihiko Fujiwara, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/391,646

(22) Filed: Mar. 20, 2003

(51) Int. Cl. G06F 9/44

(52) U.S. Cl. 717/106; 717/121; 717/168

(57) ABSTRACT

When customization is requested for MFP 1a, whether customization is already executed, is determined. When not executed, one or multiple control module to realize the customization is generated. The generated control module is supplied to MFP 1a, and stored at the same time. When executed, one or multiple control module to realize the customization among the stored control modules, is supplied to MFP 1a.

### BACKGROUND OF THE INVENTION

At least one control program is stored in a device, for example, an image forming apparatus shipped by a manufacturer and delivered to a user. The control program is stored in the image forming apparatus before delivery.

After the image forming apparatus is shipped and delivered to a user, the user may want to modify the function (a control program) of the image forming apparatus or add a new function (a control program) to the image forming apparatus.

There has been a system which enables the customization including such modification and addition of the function to meet the user's request.

For example, in the invention disclosed by Jpn. Pat. Appln. KOKAI Publication No. 10-301800, a personal computer is connected to a device, and a server supplies the personal computer with an update program. The supplied program is executed on the personal computer, and the control program stored in the device is modified.

In the invention disclosed by Jpn. Pat. Appln. KOKAI Publication No. 11-272471, many control programs required by multiple devices are previously stored in a server, and of these stored control programs, the control program required by each device is supplied to each device.

In the invention disclosed by Jpn. Pat. Appln. KOKAI Publication No. 2000-298561, a server stores the information about the customization executed for the control program of one or multiple devices, as customization information. The customization information can be referred to by the multiple devices.

However, in the prior art, it is difficult to customize each device according to individual user needs.

### BRIEF SUMMARY OF THE INVENTION

It is an object of the present invention to provide an apparatus for performing the management of devices which can customize each device suitably to meet the user's demands, and a method for performing the management of devices.

An apparatus for performing the management of devices according to the present invention comprises:

a decision section which decides whether customization is already executed, when the customization is requested for at least one of the each device;

a generator which generates one or multiple control modules to realize the customization, when the decision section decides not executed;

a communication section which supplies the generated control module to the device which is the object of the customization;

a memory which stores the generated control module as the one to be supplied to the each device; and

a communication section which extracts one or multiple control modules to realize the customization from the stored control modules, and supplies the extracted control module to the device which is the object of the customization, when the decision section decides executed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a view showing the configuration of first and second embodiments;

FIG. 2 is a view showing the configuration of a main unit of each embodiment;

FIG. 3 is a flow chart for explaining the function of the first embodiment;

FIG. 4 is a view showing an example of an initial screen for a user in the first embodiment;

FIG. 5 is a view showing an example of a screen for confirming the supply in the first embodiment;

FIG. 6 is a view showing an example of a screen for operation in the first embodiment;

FIG. 7 is a view showing another example of an initial screen for the user in the first embodiment;

FIG. 8 is a view for explaining generation of a control module when the initial screen for the user of FIG. 7 is operated;

FIG. 9 is a view showing a further example of an initial screen for the user in the first embodiment;

FIG. 10 is a view for explaining generation of a control module, when the initial screen for the user of FIG. 9 is operated;

FIG. 11 is a view showing a screen for operation displayed by the control module of FIG. 10;

FIG. 12 is a view showing another example of an initial screen for a user in the first embodiment;

FIG. 13 is a view for explaining generation of GUI control module, when the initial screen for the user of FIG. 12 is operated;

FIG. 14 is a view for explaining generation of an application control module, when the initial screen for the user of FIG. 12 is operated;

FIG. 15 is a view showing the screen for confirming the supply to be displayed when each control module of FIG. 13 and FIG. 14 is generated;

FIG. 16 is a view showing the screen for confirming the supply to be displayed when the screen of FIG. 15 is operated;

FIG. 17 is a view showing the screen for confirming the supply to be displayed when the generation of the control module in FIG. 14 is impossible;

FIG. 18 is a flow chart for explaining the function of a second embodiment;

FIG. 19 is a view showing the format of history information in the second embodiment;

FIG. 20 is a view for explaining generation of a control module in the second embodiment;

FIG. 21 is a view showing a screen for operation realized by the control module of FIG. 20; and

FIG. 22 shows a configuration of a third embodiment.

### DETAILED DESCRIPTION OF THE INVENTION

[1] A first embodiment of the present invention will be explained hereinafter.

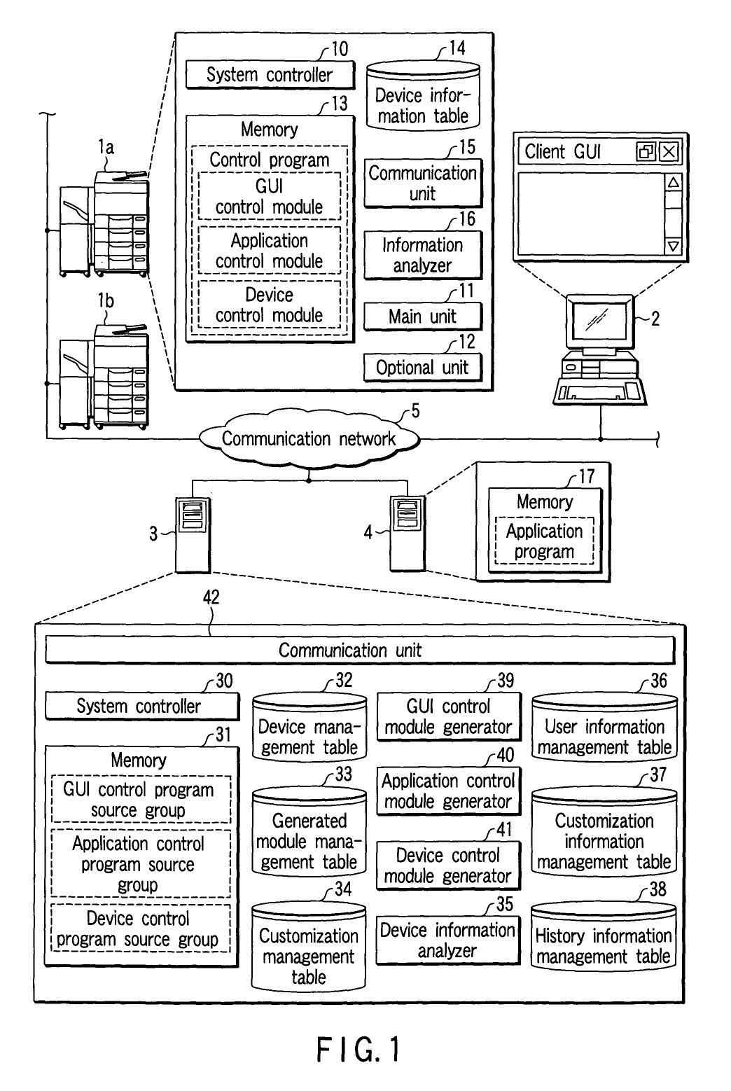

As shown in FIG. 1, a plurality of devices, for example, multi-function image forming apparatuses (hereinafter referred to as MFP) 1a, 1b, . . . , at least one user terminal (e.g., a personal computer) 2, a main server 3 or a device management apparatus, and an application server 4 are connected via a communication network 5.

MFP1a, 1b, . . . comprises a system controller 10, a main unit 11, an optional unit 12, a memory 13 for storing a control program, a device information table 14 storing the device information about the attributes of the corresponding MFP (model, performance, existence of an optional unit 12, etc.), a communication unit 15 for transfer/reception of information through the communication network 5, and an information analyzer 16 which analyzes the information about the control module received from the server 3.

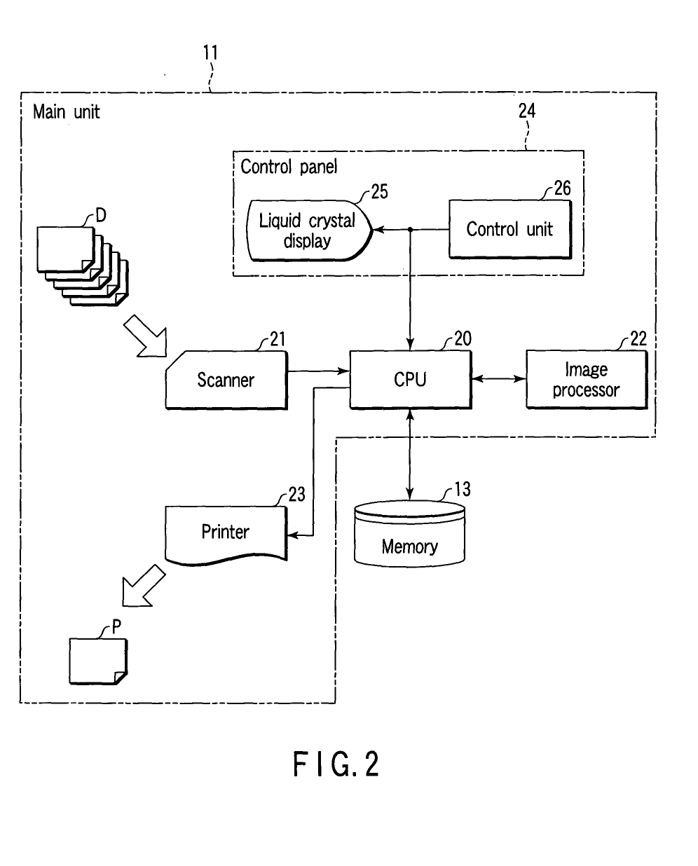

The main unit 11 comprises, as shown in FIG. 2, a CPU 20, a scanner 21 which reads the image of document D, an image processor 22 which processes the image read by the scanner 21, a printer 23 which prints on paper-sheet P the image processed by the image processor 22, and a control panel 24. The control panel 24 has a liquid crystal display 25 and a control unit 26. The liquid crystal display 25 and control unit 26 may constitute a touch-panel type liquid crystal display. The optional unit 12 is a FAX interface, for example.

The memory 13 reloadably stores the control program for controlling the corresponding MFP. This control program comprises a GUI (Graphical User Interface) control module to control the display of the liquid crystal display 25, an application control module to realize a specific function in the corresponding MFP by cooperating with the application program stored in the memory 17 of the application server 4, and a device control module to control the main unit 11 and optional unit 12.

The user of MFP 1a, 1b, . . . can request customization of at least one of MFP 1a, 1b, . . . by operating the control panel 24 or user terminal 2.

The main server 3 comprises a system controller 30, a memory 31 to store a program source, a device management table 32, a generation module management table 33, a customization management table 34, a device information analyzer 35, a user information management table 36, a customization information management table 37, a history information management table 38, a GUI control module generator 39, an application control module generator 40, a device control module generator 41, and a communication unit 42.

The memory 31 stores a group of program sources to control the GUI, a group of program sources to control applications, and a group of program source to control devices. The device management table 32 stores the network addresses and attributes of MFP 1a, 1b, The generation module management table 33 stores the information (e.g., a control module name) about one or multiple control modules which is generated by the generators 39, 40, 41 and can be supplied (so-called download) to MFP 1a, 1b, . . . . For example, the generation module management table 33 stores the information indicating the possibility of suppling one or multiple control modules to add new functions (e.g., a maintenance function) to MFP 1a, 1b, . . . , the information indicating the possibility of sending one or multiple control modules to modify the defects of the functions of MFP 1a, 1b, . . . , and the information indicating the possibility of sending one or multiple control modules to change the functions of MFP 1a, 1b, to the functions with more convenience.

For each user of MFP 1a, 1b, . . . , and for each group or set of users, the authority level of limiting the customization of MFP 1a, 1b, . . . , is hierarchically defined. The user and group with a higher authority level are limited less in customization, while the user and group with lower authority level are limited more in customization.

In the customization management table 34, one or multiple executable customizations are corresponded to the names of control modules to realize the customization, and sorted for each authority level of the users and groups for each attribute of MFP 1a, 1b, . . . . When the executable customization includes an alternative customization, the alternative customization and the control module name to realize that customization are corresponded and stored in the customization management table 34.

The device information analyzer 35 analyzes the attributes of MFP which is the object of the customization requested by the user.

The user information management table 36 stores the user information (an individual name, group name, password, authority level, etc.) concerning all the users of MFP 1a, 1b, . . . . The customization information management table 37 stores a customizing method (a frame work, or the like). The history information management table 38 stores the history information concerning the executed customization (generation of a control module) each time the customization is executed.

The GUI control module generator 39 extracts at least one or multiple program sources from the group of program sources to control the GUI in the memory 31, based on the contents of the customization requested by the user, the information stored in the device management table 32 and the information stored in the customization management table 34, and edits the extracted program source to generate at least one GUI control program (called a GUI control module). The application control module generator 40 extracts at least one or multiple program sources from a group of program sources to control applications in the memory 31, based on the contents of the customization requested by the user, the information stored in the device management table 32, and the information stored in the customization management table 34, and edits the extracted program source to generate at least one application control program (called an application control module). The device control module generator 41 extracts at least one or multiple program sources from a group of program sources to control devices in the memory 31, based on the contents of the customization requested by the user, the information stored in the device management table 32 and the information stored in the customization management table 34, and edits the extracted program source to generate at least one device control program (called a device control module).

The communication unit 42 transmits and receives information to/from MFP 1a, 1b, . . . , user terminal 2, main server 3 and application server 4.

The communication unit 42 and system controller 30 has the following means (1)-(16) as main functions.

(1) An identification means for identifying the user and MFP, when the user of MFP 1a, 1b, . . . requests customization for each MFP.

(2) A selection means for selecting one or multiple customization defined executable for the identified user and MFP.

(3) A communication means for notifying the selected customization to the identified user, and making the identified user specify at least one of the notified customization.

(4) A means for analyzing the attributes of the identified MFP by the device information analyzer 35.

(5) A first decision means for deciding whether the specified customization is actually valid for the identified MFP, according to the result of the analysis.

(6) A second decision means for deciding whether the specified customization is already executed, when the first decision means decides valid.

(7) A means for generating by the generators 39, 40 and 41 one or multiple control modules (a control program) to realize the specified customization, when the second decision means decides not executed.

(8) A communication means for supplying the generated control module to the identified MFP.

(9) A control means for storing the generated control module in the communication unit 42 as the one for supplying to MFP 1a, 1b, . . . .

(10) A communication means for extracting one or multiple control modules to realize the specified customization from the control modules stored in the communication unit 42, and supplying the extracted control module to the identified MFP, when the second decision means decides executed.

(11) A third decision means for deciding whether the specified customization includes an alternative customization, when the first decision means decides not valid.

(12) A fourth decision means for deciding whether the alternative customization is already executed, when the third decision means decides included.

(13) A means for generating by the generators 39, 40 and 41 one or multiple control modules to realize the alternative customization, when the fourth decision means decides not executed.

(14) A communication means for supplying the control module generated by the means (13) to the identified MFP.

(15) A control means for storing the control module generated by the means (13) in the communication unit 42 as the one for supplying to MFP 1a, 1b, . . . .

(16) A communication means for extracting one or multiple control modules to realize the alternative customization, from the control modules stored in the communication unit 42, and supplying the extracted control module to the identified MFP, when the fourth decision means decides executed.

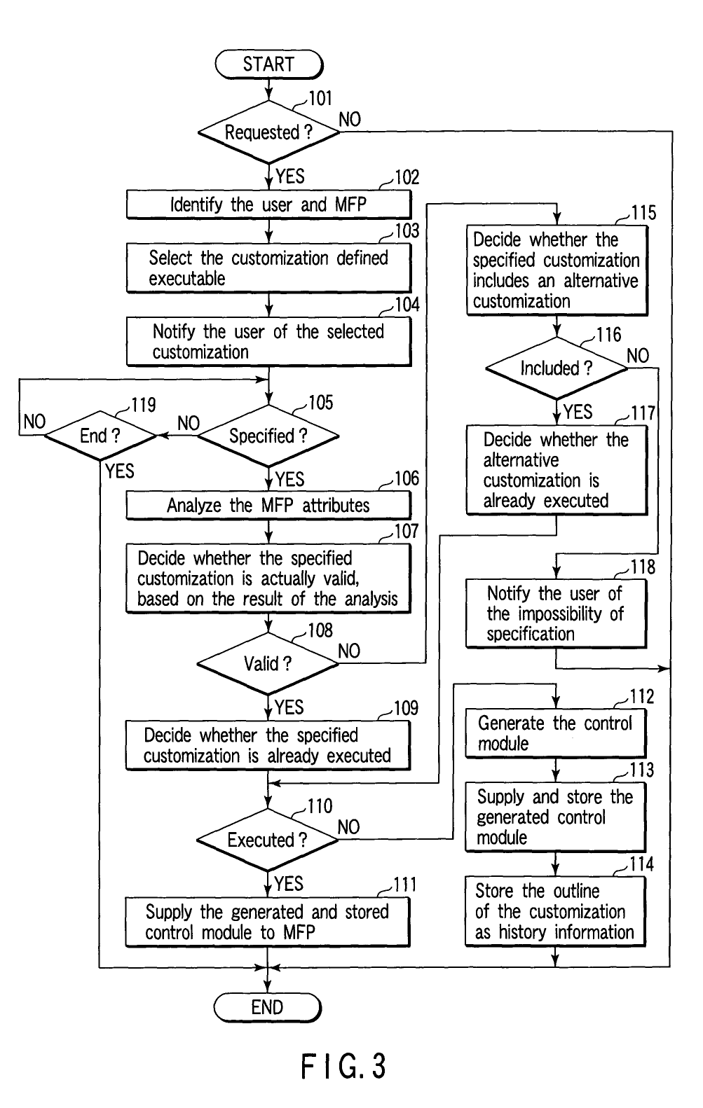

Next, the function will be explained by referring to the flow chart of FIG. 3.

Description will be given on a case where the user X of MFP 1a customizes MFP 1a.

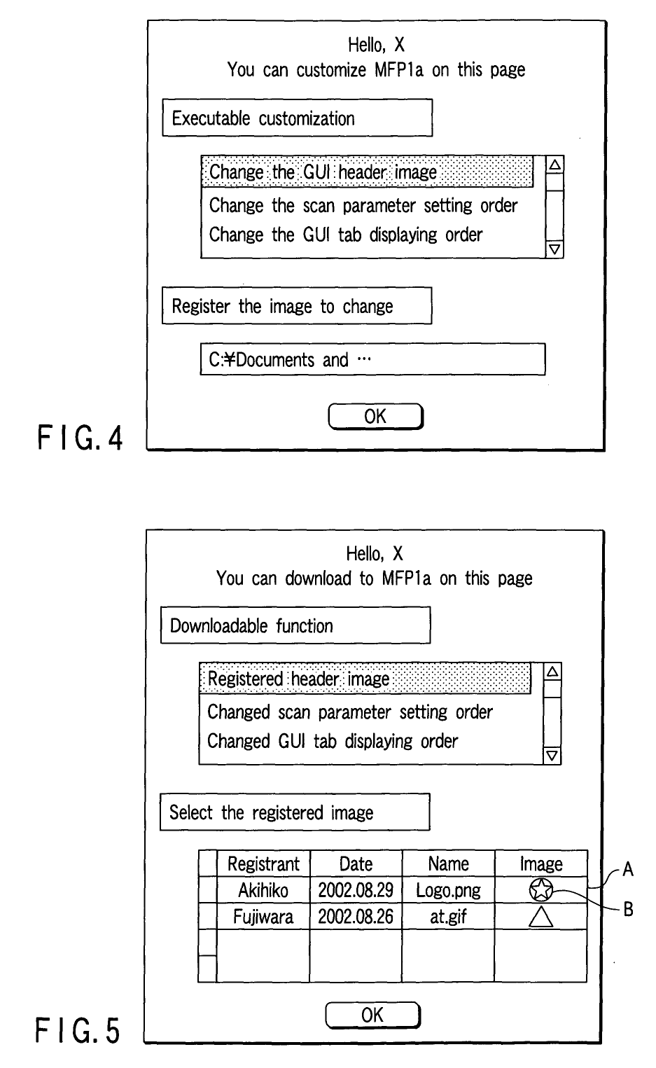

When the user terminal 2 is operated by the user X and customization of MFP 1a is requested (YES in step 101), the user X and MFP 1a are identified by the main server 3 (step 102). Based on the result of the identification, the customization management table 34 is referred to, and one or multiple customization defined executable for the user X and MFP 1a is selected (step 103). Namely, when the authority level of the user X is high, the number of selected customization is more. Contrarily, when the authority level of the user X is low, the number of selected customization is less. The selected customization is supplied to the user terminal 2, and indicated in the display of the user terminal 2. An example of the display screen is shown in FIG. 4. FIG. 4 is an initial screen for a user when customizing the header image in the screen for operation displayed in the liquid crystal display 25 of MFP 1a.

When one customization is specified in the user initial screen (YES in step 105), the attributes of MFP 1a to be customized are analyzed (step 106). Based on the result of analysis, whether the specified customization is actually valid for the MFP 1a, is determined (step 107). For example, when the specified customization is the customization of a FAX function and the optional unit 12 in the MFP 1a to be customized is a FAX interface, the specified customization is judged valid. If the specified customization is the customization of a FAX function and the optional unit 12 in the MFP 1a to be customized is not a FAX interface, the specified customization is judged invalid.

When the specified customization is valid (YES in step 108), the generation module management table 33 is referred to and whether the specified customization is already executed, is determined (step 109).

When already executed (YES in step 110), among the control modules which are already generated and stored in the communication unit 42, the control module to realize the specified customization is supplied to MFP 1a (step 111). This supply is started by the user by operating the user terminal 2.

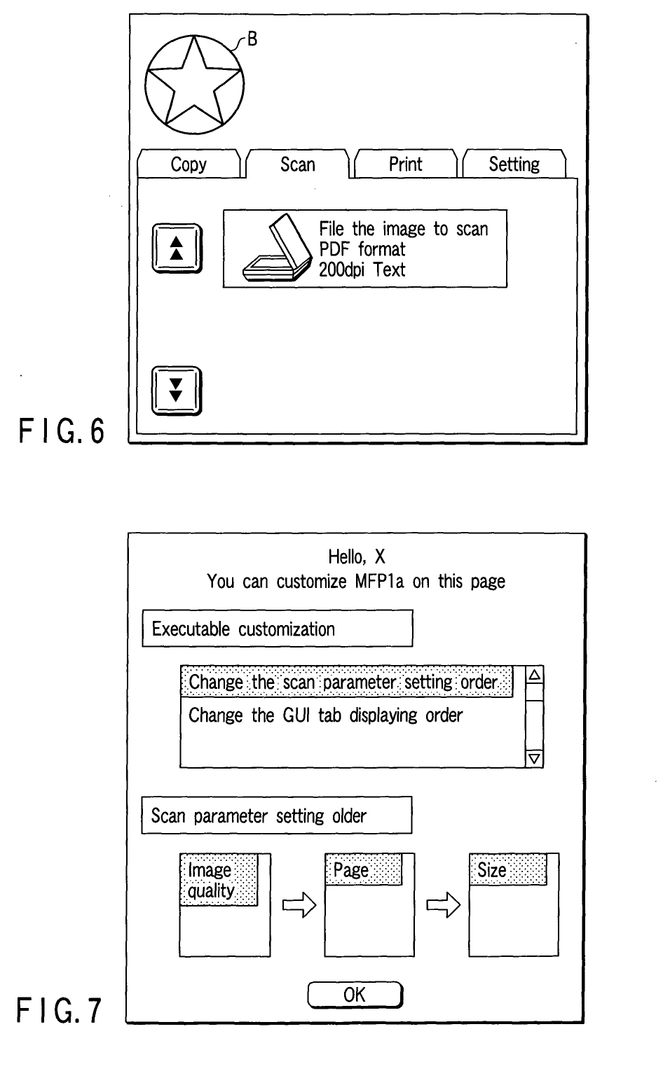

That is, the supply confirmation screen shown in FIG. 5 is indicated in the display of the user terminal 2, and a desired item in the screen is specified by the user by operating the cursor, and the control module corresponding to the specification is supplied to MFP 1a. The supplied control module is added to the control program stored in the memory 13 of MFP 1a. The screen for operation shown in FIG. 6 is then displayed in the liquid crystal display 25 of MFP 1a. The header image B in this screen for operation corresponds to the image B which is registered in the column A in the display screen of FIG. 5.

When not executed (NO in step 110), one or multiple control modules to realize the specified customization is generated by one of the generators 39, 40 and 41, according to the customizing method (a frame work or the like) stored in the customization information management table 36 (step 112). The generated control module is supplied from the communication unit 42 to MFP 1a, and stored in the communication unit 42 (step 113). And, the outline of the customization of this time is stored in the history information management table 38 as history information (step 114).

When the specified customization is invalid (NO in step 108), the customization management table 34 is referred to, and whether customization substitutive for the specified customization exists, is determined (step 115).

As substitutive customization, there is addition of a function, for example, adding a FAX interface of MFP 1a, 1b, . . . to the FAX interface of the personal computer (not shown) connected to MFP 1a, 1b, . . . through the network.

When such a substitutive customization exists (YES in step 116), whether the substitutive customization is already executed, is determined (step 117). When executed (YES in step 110), among the control modules which are already generated and stored in the communication unit 42, the control module to realize the substitutive customization is supplied to MFP 1a (step 111). When not executed (NO in step 110), one or multiple control modules to realize the substitutive customization is generated by one of the generators 39, 40 and 41 (step 112). The generated control module is supplied from the communication unit 42 to MFP 1a, and stored in the communication unit 42 (step 113). And, the outline of the customization of this time is stored in the history information management table 38 as history information (step 114).

When substitutive customization does not exist (NO in step 116), the impossibility of specification is notified to the user by the display in the user terminal 2 (step 118).

When the end is specified in the initial screen for the user in the display of the user terminal 2 (YES in step 119) before customization is not specified in that initial screen for the user (NO in step 105), the process is finished.

The above description is given on the case where MFP 1a is customized according to the request by the user X. It is also possible to customize MFP 1b according to the request by the user X.

As explained above, when the MFP 1a is customized according to the request by the user X, the control module generated to realize the customization is stored in the communication unit 42 of the main server 3, and the stored control module can be supplied to MFP 1b according to the request by the user X. Therefore, it is possible to execute suitable customization for MFP 1a, 1b, . . . easily and speedily, according to the preference of the user X. That is, the convenience of MFP 1a, 1b, . . . is greatly improved.

Execution of customization is limited according to the authority level of the user X, and the safety is ensured.

Even for the customization executable to MFP 1a, if that customization is not valid for the current MFP 1a, an alternative customization is executed, and the serviceability for the user is improved.

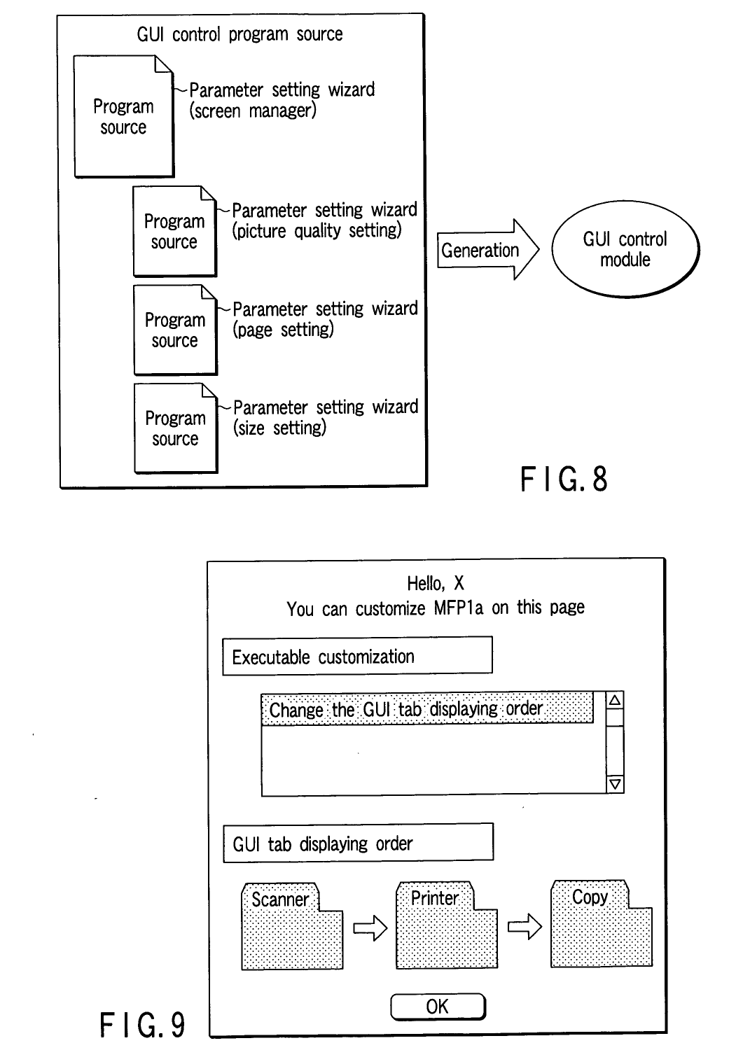

FIG. 7 is the initial screen for the user when customizing (changing) the order of setting each scan parameter in the screen for operation displayed in the liquid crystal display 25 of MFP 1a, 1b, . . . . By operating in the initial screen for the user, a plurality of program sources for a parameter setting wizard are extracted from a group of program sources for controlling the GUI stored in the memory 13, and the GUI control module is generated from the extracted program sources, as shown in FIG. 8.

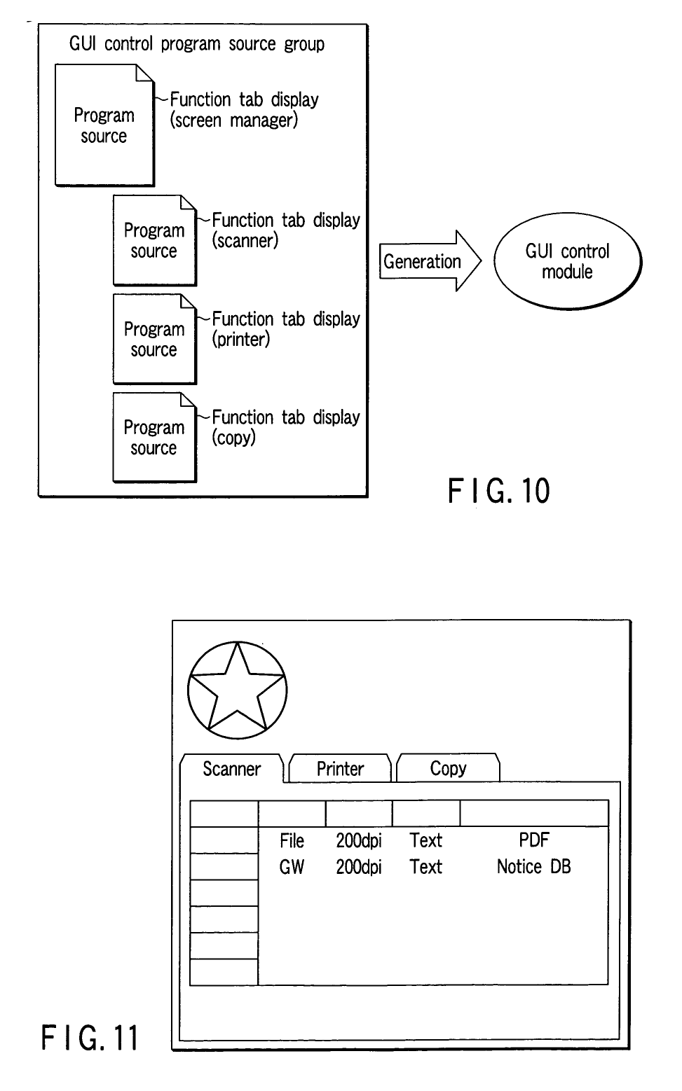

FIG. 9 is the initial screen for the user when customizing (changing) the order of displaying each tab in the screen for operation displayed in the liquid crystal display 25 of MFP 1a, 1b, . . . . By operating in the initial screen for the user, a plurality of program sources for displaying the tabs are extracted from a group of program sources for controlling the GUI stored in the memory 13, and the GUI control module is generated from the extracted program sources, as shown in FIG. 10. The GUI control module is supplied to MFP 1a, and the screen for operation shown in FIG. 11 is displayed in the liquid crystal display 25 of MFP 1a.

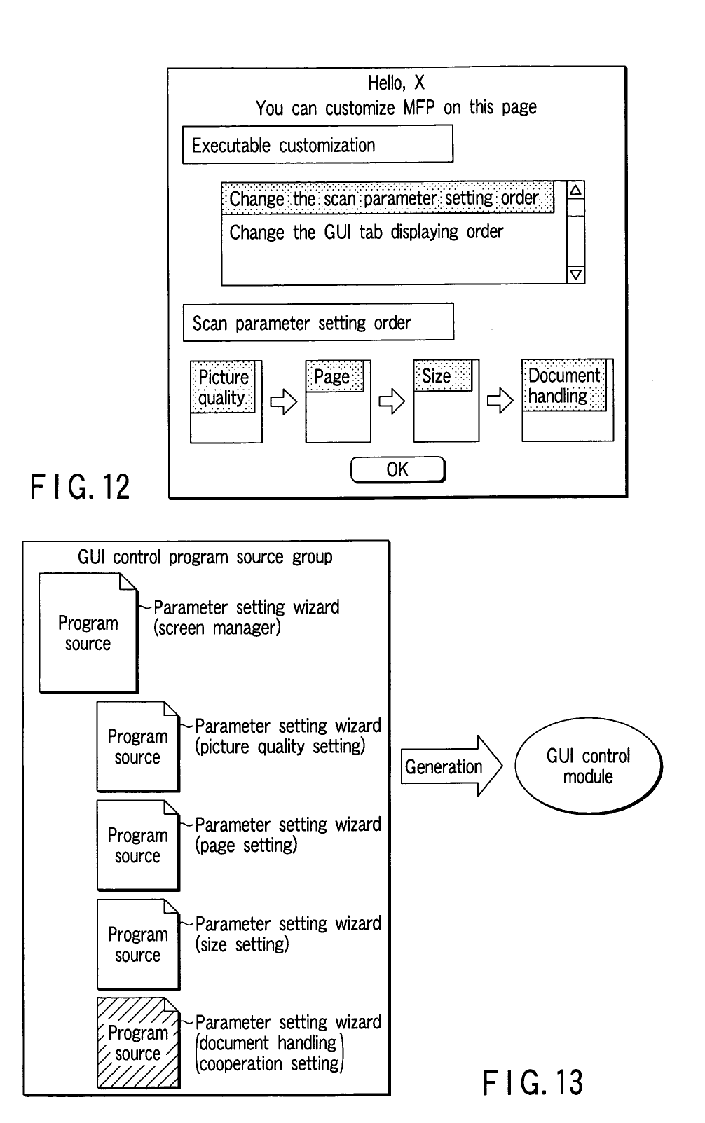

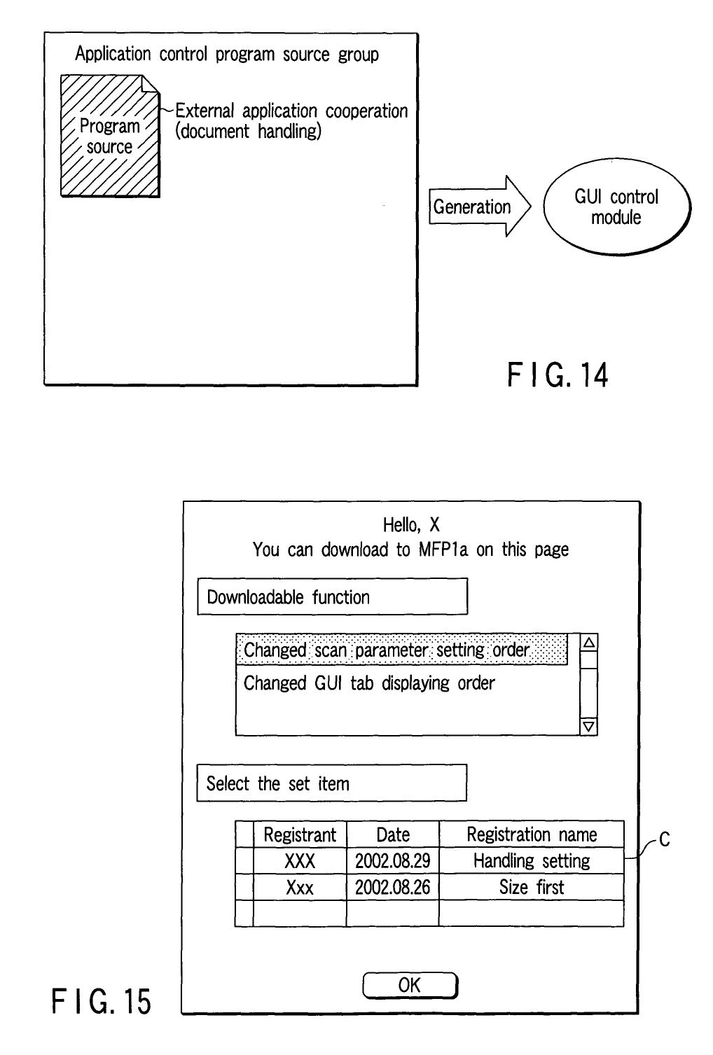

FIG. 12 is the initial screen for the user when customizing (changing) the order of setting each scan parameter in the screen for operation displayed in the liquid crystal display 25 of MFP 1a, 1b, . . . . By operating in the initial screen for the user, a plurality of program sources for a parameter setting wizard are extracted from a group of program sources for controlling the GUI stored in the memory 13, and the GUI control module is generated from the extracted program sources, as shown in FIG. 13. At the same time, as shown in FIG. 14, one program source for cooperating with an external application is extracted from the group of program sources for controlling the applications stored in the memory 13, and the application control module is generated from the extracted program source. The program source for cooperating with an external application realizes a specific function in MFP 1a, 1b, . . . by cooperating with the application programs stored in the memory 17 of the application server 4, together with one program source in the group of program sources for controlling the GUI, as shown shaded in FIGS. 13 and 14.

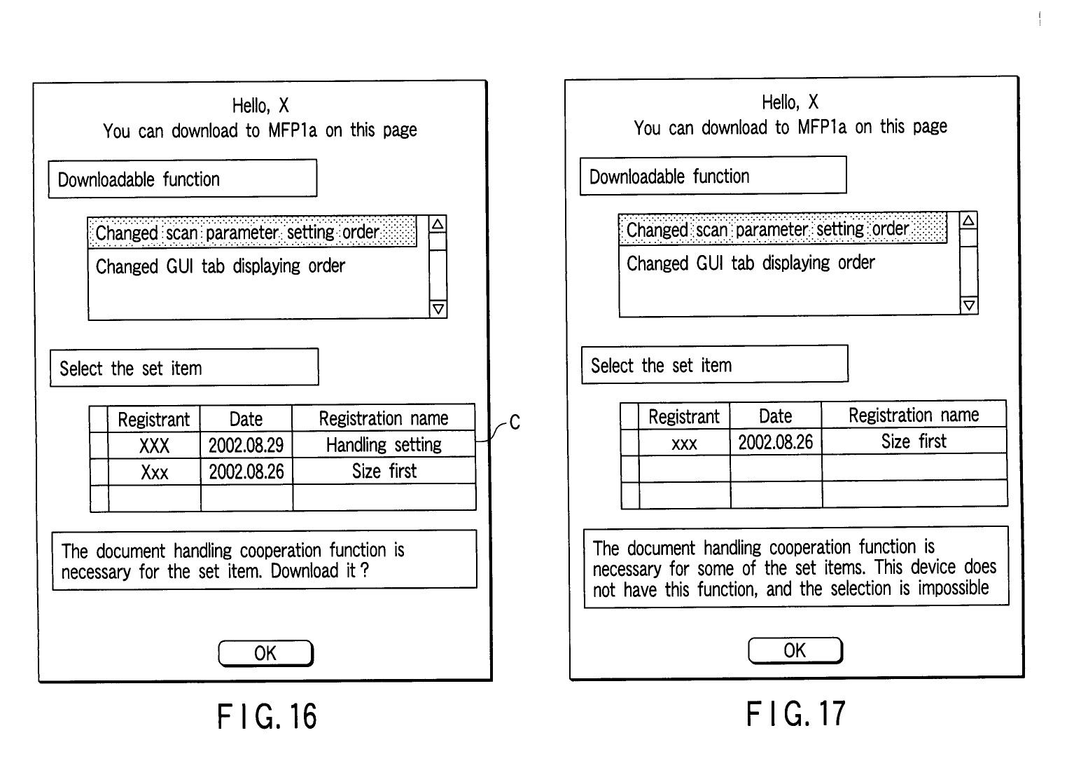

When the GUI control module of FIG. 13 and the application control module of FIG. 14 are generated, the screen shown in FIG. 15 for notifying the user X of the possibility of supply of the generated GUI control module, is indicated in the display of the user terminal 2. When the user specifies the item C on this display screen by operating the cursor, the screen shown in FIG. 16 for notifying the user of the necessity of supplying the generated application control module, is indicated in the display of the user terminal 2. When the user X specifies the OK button in this display screen of FIG. 16 by operating the cursor, both the generated GUI control module and application control module are supplied to MFP 1a. By this supply, the display function of setting the parameter and the function of cooperating with the external application program (e.g., a document handling system) are added to MFP 1a.

However, with the attributes of MFP 1a, it is impossible to add the function of cooperating with the external application program (e.g., a document handling system), and an alternative function may not exist. In this case, as shown in FIG. 17, the screen for notifying the user of the possibility of supplying only the control module to realize the other functions except the cooperating function, is indicated in the display of the user terminal 2.

[2] A second embodiment of the present invention will be explained.

In the first embodiment, one or multiple control modules is generated and stored in the communication unit 42. But, in the second embodiment, whenever customization is requested, one or multiple control modules is generated and sequentially supplied to MFP 1a, 1b, . . . . The generated control module is not stored in the communication unit 42, and the storage capacity of the communication unit 42 can be reduced.

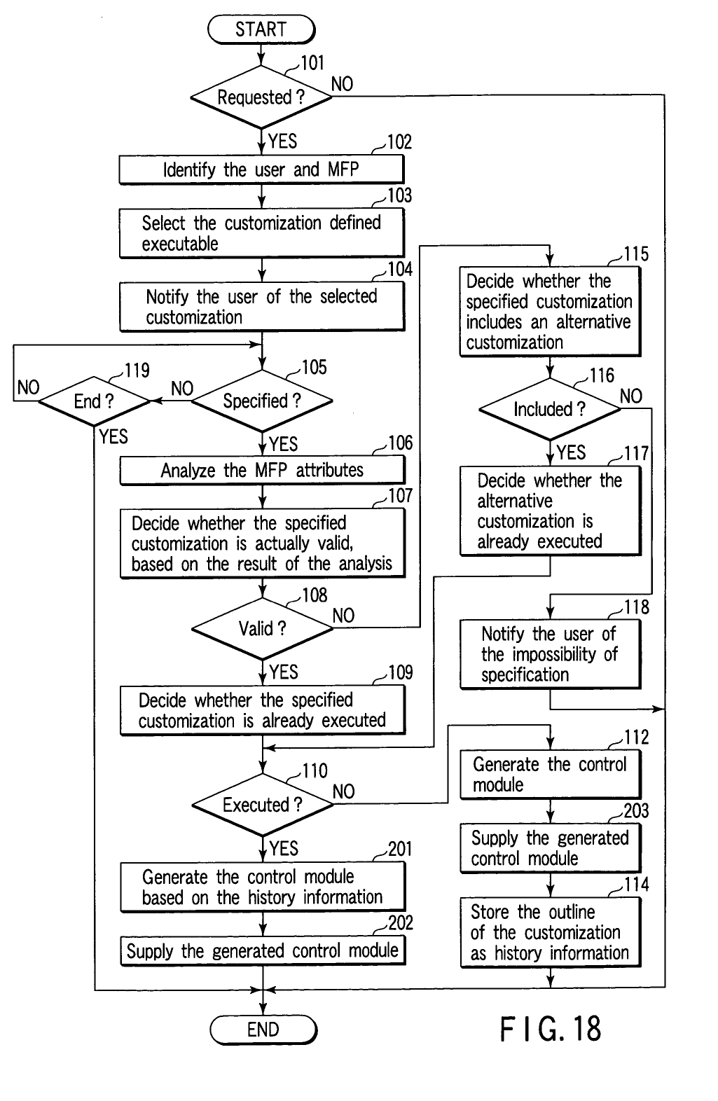

As shown in the flow chart of FIG. 18, steps 201 and 202 are executed instead of step 111 in the flow chart of FIG. 3. Further, step 203 is executed instead of step 113 in the flow chart of FIG. 3.

Namely, when the customization specified by the user is valid (YES in step 108), the generation module management table 33 is referred to, and whether the specified customization is already executed, is determined (step 109).

When executed (YES in step 110), based on the history information (the outline of customization) stored in the history information management table 38, one or multiple control modules to realize the specified customization is generated by one of the generators 39, 40 and 41 (step 201). The generated control module is supplied from the communication unit 42 to MFP 1a (step 202).

When not executed (NO in step 110), according to the customizing method stored in the customization information management table 36, one or multiple control modules to realize the specified customization is generated by one of the generators 39, 40 and 41 (step 112). The generated control module is supplied from the communication unit 42 to MFP 1a (step 203). And, the outline of the customization of this time is stored in the history information management table 38 as history information (step 114).

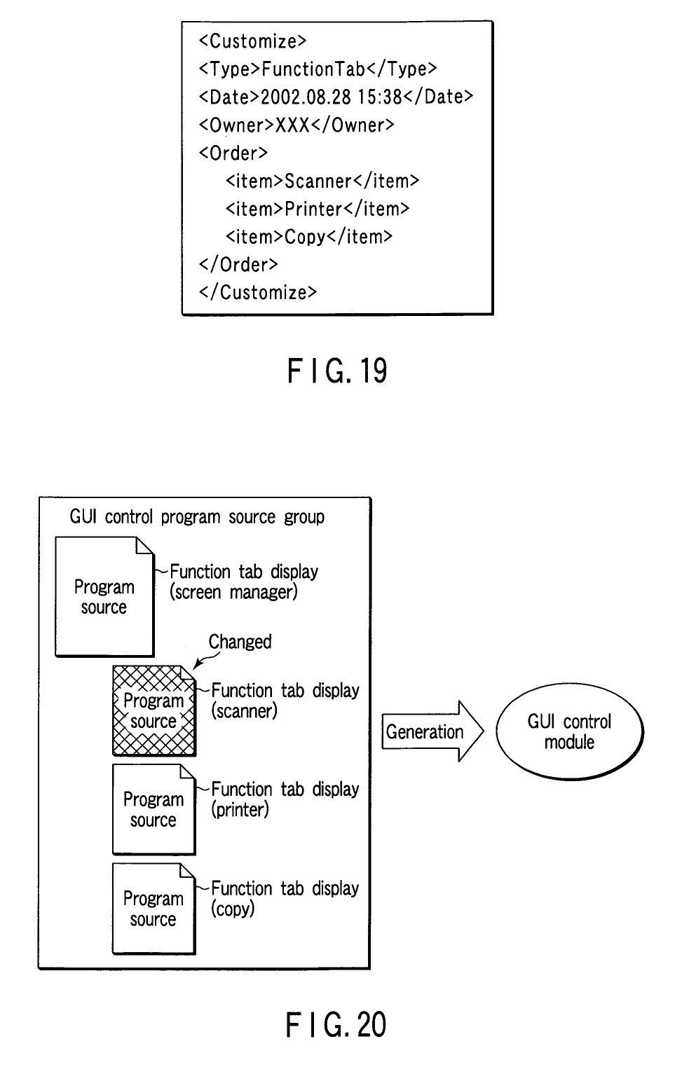

FIG. 19 shows an example of the format of “the outline of the customization” stored in the history information management table 38. Namely, when the order of displaying the tabs in the screen for operation in the liquid crystal display 25 is customized, the names of each tab (Scanner, Printer, Copy) are stored in the same order. That is, “the outline of the customization” merely indicates the tab display order itself, and does not include the detailed process of what program source is extracted from the program source group, and how to edit.

Since the control module is generated based on the “the outline of the customization” stored in the history information management table 38, as mentioned above, even if one program source for displaying the tab in the program source group for controlling GUI is changed (improved, for example), as shown shaded in FIG. 20, the same GUI control module as the tab displaying GUI control module generated in the past can be re-generated without being influenced by the change.

Namely, even if one program source in the program source group for controlling GUI is changed, the same control module as the control module generated in the past can be securely generated without inserting the changed contents into the customizing method stored in the customization information management table 36.

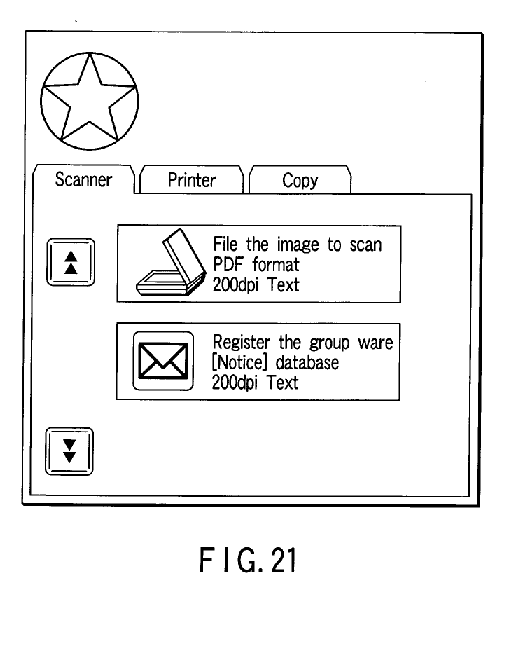

The control module generated as described above is supplied to MFP 1a, and the screen for operation shown in FIG. 21 is displayed in the liquid crystal display 25 of MFP 1a. This screen for operation is a little different from the screen for operation shown in FIG. 11, because one program source for displaying the tab is changed.

The other configuration, function and effect are the same as those of the first embodiment.

[3] A third embodiment of the present invention will be explained.

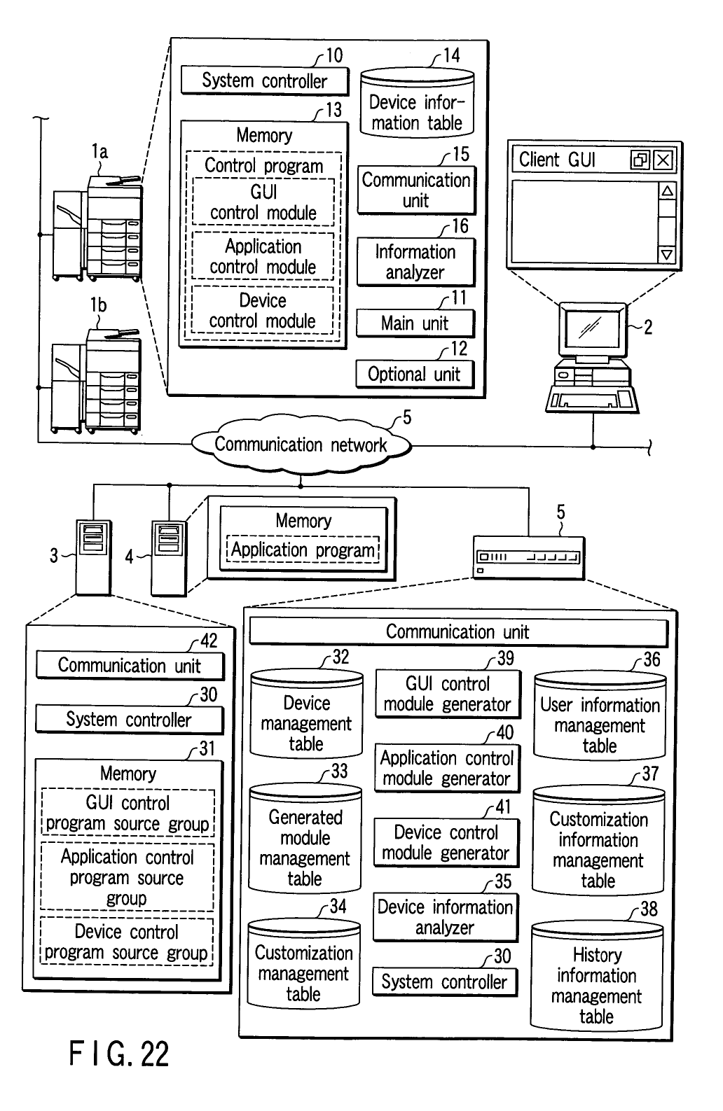

As shown in FIG. 22, a part of the structure of the main server 3 is shifted to an appliance server 5 connected to a communication network 2. Information is transferred between the main server 3 and appliance server 5, and the same control as that in the first embodiment or second embodiment is executed.

The other configuration, function and effect are the same as those of the first embodiment or second embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for performing the management of devices, comprising:
a decision section which decides whether customization is already executed, when the customization is requested for at least one of said each device;
a generator which generates one or multiple control modules to realize the customization, when the decision section decides not executed;
a communication section which supplies the generated control module to the device which is the object of the customization;
a memory which stores the generated control module as the one to be supplied to said each device; and
a communication section which extracts one or multiple control modules to realize the customization from the stored control modules, and supplies the extracted control module to the device which is the object of the customization, when the decision section decides executed.

2. The apparatus according to claim 1, further comprising:
an identification section which identifies the originator of the request; and
a control section which limits execution of the customization according to the result of the identification.

3. The apparatus according to claim 2, wherein the identification section identifies the authority level defined for the originator.

4. An apparatus for performing the management of devices, comprising:
an identification section which identifies the requesting user and the device which is the object of the customization, when the user of said each device requests customization for each device;
a selector section which selects one or multiple customization defined executable for the identified user and device;
a communication section which notifies the identified user of the selected customization, and makes the identified user to specify at least one of the notified customization;
an analyzer which analyzes the attributes of the identified device;
a first decision section which decides whether the specified customization is actually valid for the identified device, according to the result of the analysis;
a second decision section which decides whether the specified customization is already executed, when the first decision section decides valid;
a generator which generates one or multiple control modules to realize the specified customization, when the second decision unit decides not executed;
a communication section which supplies the generated control module to the identified device;
a memory which stores the generated control module as the one to be supplied to said each device; and
a communication section which extracts one or multiple control modules to realize the customization from the stored control modules, and supplies the extracted control module to the identified device, when the second decision section decides executed.

5. The apparatus according to claim 4, wherein the identification section identifies the authority level defined for the user.

6. The apparatus according to claim 4, further comprising:
a third decision section which decides whether customization substitutive for the specified customization exists, when the first decision section decides not valid;
a fourth decision section which decides whether the substitutive customization is already executed, when the third decision section decides exist;
a second generator which generates one or multiple control modules to realize the substitutive customization, when the fourth decision unit decides not executed;
a communication section which supplies the control module generated by the second generator to the identified device;
a control section which stores the control module generated by the second generator in the memory as the one to be supplied to said each device; and
a sixth communication section which when the fourth decision section decides executed, extracts one or multiple control modules to realize the substitutive customization from the control modules stored in the memory, and supplies the extracted control module to the identified device.

7. An apparatus for performing the management of devices, comprising:
a decision section which decides whether customization is already finished, when the customization is requested for at least one of said each device;
a first generation section which generates one or multiple control modules to realize the customization, when the decision section decides not executed;
a communication section which supplies the control module generated by the first generator to the device to be customized;
a memory which stores the history information about the generator of the control module generated by the first generator;
a second generator which generates one or multiple control modules to realize the customization, based on the history information stored in the memory, when the decision unit decides executed; and
a communication section which supplies the control module generated by the second generator to the device which is the object of the customization.

8. The apparatus according to claim 7, further comprising:
an identification section which identifies the originator of the request; and
a control section which limits execution of the customization according to the result of the identification.

9. The apparatus according to claim 7, wherein the identification section identifies the authority level defined for the originator.

10. A method for performing the management of devices, comprising:
deciding whether customization is already finished when the user of said each device requests the customization for at least one of said each device;
generating one or multiple control modules to realize the customization, when the decision unit decides not executed;
supplying the generated control module to the device which is the object of the customization;
storing the generated control module as the one to be supplied to said each device; and
extracting one or multiple control modules to realize the customization from the stored control modules, and supplying the extracted control module to the device which is the object of the customization, when the decision unit decides executed.

11. The method according to claim 10, further comprising:
identifying the request source user, when the user of said each device requests customization for said each device; and
limiting execution of the customization according to the result of the identification.
